(19) United States
(12) Patent Application Publication
(10) Pub. No.: US 2006/0191628 A1
(43) Pub. Date: Aug. 31, 2006

(54) Method and kit for making templates for countertops

(76) Inventors: George Chapman, Buford, GA (US); Carolyn Chapman, Buford, GA (US)

Correspondence Address: LITMAN LAW OFFICES, LTD, PO BOX 15035, CRYSTAL CITY STATION, ARLINGTON, VA, 22215, US

(21) Appl. No.: 11/067,012

(22) Filed: Feb. 28, 2005

(51) Int. Cl. B32B 38/04; B32B 37/00

(52) U.S. Cl. 156/250; 156/256; 156/297

(57) ABSTRACT

A method of making a template for a countertop, the template being usable to form a countertop configured for application to an existing countertop-receiving structure, includes the steps of dimensioning the existing countertop-receiving structure with a plurality of strips of a flexible material and adhering the dimensioned strips of flexible material to one another to form the integrated template. If a rounded or contoured shape for the countertop is desired, the dimensioned strips may be cut to depict this desired design. A kit for making a template for a countertop according to this method includes one or more rolls of a flexible strip material, an adhesive, an adhesive dispenser, a funnel, and a pair of scissors. This method and kit made it easy and efficient to create a countertop template that is lightweight and can be easily rolled up or folded up for storing and shipping.

### BACKGROUND OF THE INVENTION

1. Field of the Invention

The present invention relates to template making, and particularly to a method and kit for making templates for countertops.

2. Description of the Related Art

Creation and installation of countertops for countertop-receiving structures, such as cabinet sets, can often cause difficulties due to bulk of the materials and tools that are required to perform the necessary tasks.

Countertops are often constructed from granite, quartz, engineered stone and other materials that are so heavy that is not practical for the material to be sized and cut at the job site. Therefore, templates are often created on site to properly dimension the shape of the desired countertop. These templates can then be sent to a cutting site where the countertop is created, using the template as a guide.

Unfortunately, the creation of these templates can be an arduous task. The templates are traditionally created from pieces of plywood or other rigid materials. Table saws, gig saws, drills, and other cumbersome tools must be carried onto the job site to create a template out of the plywood material. The resulting template is often heavy and too large to be easily transported or shipped. Also, there is the possibility that the template may shrink or break due to moisture build-up and ruin the integrity of the desired countertop design.

What is needed is a method for creating countertop templates that requires no heavy and bulky materials and no oversized power tools. It is also desired that the method be efficient and that the resulting template be easy to ship and store. It is further desired that all the materials needed to create a template using such a method be available together as a kit.

Thus, a method and kit for making templates for countertops solving the aforementioned problems is desired.

### SUMMARY OF THE INVENTION

A method of making a template for a countertop, the template being usable to form a countertop configured for application to an existing countertop-receiving structure, includes the steps of dimensioning the existing countertop-receiving structure with a plurality of strips of a flexible material and adhering the dimensioned strips of flexible material to one another to form the integrated template. If a rounded or contoured shape for the countertop is desired, the dimensioned strips may be cut to depict this desired design.

Ideally, the strips will be of varying widths, such that the width of each strip is equal to the width of the surface of the countertop-receiving structure to which it corresponds. In the case where an overhanging countertop is desired, a wider strip may be dimensioned for that portion of the countertop-receiving structure where the overhang is desired, the amount of overhang being shown by the distance the strip extends beyond the surface of the countertop-receiving structure. Notations as to the desired shape and design of the countertop can also be made by writing on the surface of the strips themselves.

In the alternative, if an overhanging countertop is desired, one or more additional strips of flexible material can be adhered to the dimensioned strips of flexible material, the one or more additional strips each extending a length beyond the surface of the countertop-receiving structure, with each length representing a desired overhang on the countertop. Again, notations as to the desired shape and design of the countertop can be made by writing on the surface of the strips themselves.

A kit for making a template for a countertop according to these described methods includes one or more rolls of a flexible strip material, an adhesive, an adhesive dispenser, a funnel, and a pair of scissors. The funnel is adapted so that is may be connected to the adhesive dispenser, thus making it easier to dispense a small amount of adhesive to a desired location on one of the strips of flexible material. Ideally, the flexible material would be polyvinyl chloride, polystyrene, Sintra™, or Kydex™.

This method and kit made it easy and efficient to create a countertop template that is lightweight and can be easily rolled up or folded up for storing and shipping.

These and other features of the present invention will become readily apparent upon further review of the following specification and drawings.

### BRIEF DESCRIPTION OF THE DRAWINGS

FIG. 1 is a flowchart showing the steps of a method of making a template for a countertop according to the present invention.

FIG. 2 is a flowchart showing the steps of a method of making a template for a countertop according to the present invention.

FIG. 3 is a perspective view of a countertop-receiving structure displaying a method of making a template for a countertop according to the present invention.

FIG. 4 is a partial perspective view of a countertop-receiving structure displaying a method of making a template for a countertop according to the present invention.

FIG. 5 is a partial perspective view of a countertop-receiving structure displaying a method of making a template for a countertop according to the present invention.

FIG. 6 is a partial perspective view of a countertop-receiving structure displaying a method of making a template for a countertop according to the present invention.

FIG. 7 is a partial perspective view of a countertop-receiving structure displaying a method of making a template for a countertop according to the present invention.

Similar reference characters denote corresponding features consistently throughout the attached drawings.

### DETAILED DESCRIPTION OF THE PREFERRED EMBODIMENTS

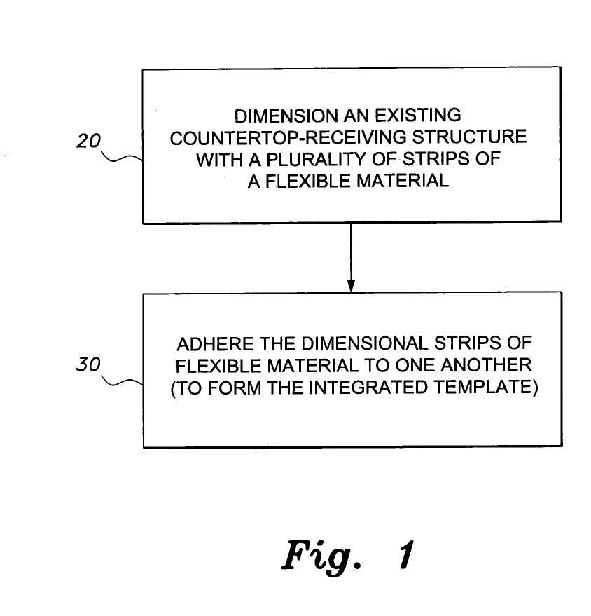

The present invention includes a method of making a template for a countertop, and is best illustrated by the process shown in FIG. 1.

Creation and installation of countertops for countertop-receiving structures, such as cabinet sets, can often cause difficulties due to bulk of the materials and tools that are required to perform the necessary tasks. Templates are often created on site to properly dimension the shape of the desired countertop. These templates can then be sent to a cutting site where the countertop is created, using the template as a guide. The templates are traditionally created from pieces of plywood or other rigid materials. Table saws, gig saws, drills, and other cumbersome tools must be carried onto the job site to create a template out of the plywood material. The resulting template is often heavy and too large to be easily transported or shipped. Also, there is the possibility that the template may shrink or break due to moisture build-up and ruin the integrity of the desired countertop design. The present invention offers a new method and kit by which the construction industry may create on-site countertop templates that are lightweight, require no bulky materials or tools, and can be easily rolled up or folded up for storing and shipping.

As shown in FIG. 1, the process begins by dimensioning the existing countertop-receiving structure with a plurality of strips of a flexible material, as indicated in block 20. Preferably, the strips are provided as rolls in lengths that are most commonly seen in countertop-receiving structures, such as cabinet sets. A strip is dimensioned for each surface of the countertop-receiving structure. Also, the strips of flexible material are intended to have varying widths, such that the width of each strip corresponds to the width of the surface of the countertop-receiving structure that it represents.

If it is desired that a portion of the countertop is to overhang a portion of the countertop-receiving structure, strips that are wider than the surface of the countertop-receiving structure they represent can be used instead, the distance that each strip extends beyond the surface of the countertop-receiving structure representing the desired amount of overhang.

The final step involves adhering the dimensioned strips to one another to form the integrated template, as indicated in block 30. The dimensioned strips may be adhered to one another by placing a small amount of adhesive at the end of each strip in the integrated template design.

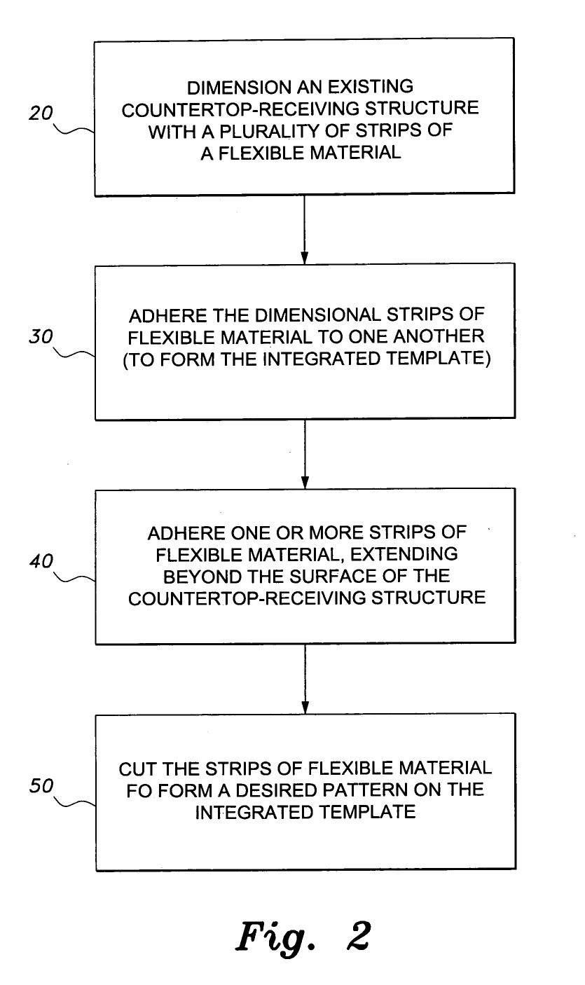

FIG. 2 shows alternate and additional steps that may be included in the process. Again, the process begins by dimensioning the existing countertop-receiving structure with a plurality of strips of a flexible material, as indicated in block 20. Next, the dimensioned strips are adhered to on another, as indicated in block 30. Again, the strips of flexible material are intended to have varying widths, such that the width of each strip corresponds to the width of the surface of the countertop-receiving structure that it represents. However, in this instance, if it is desired that a portion of the countertop is to overhang a portion of the countertop-receiving structure, one or more additional strips of flexible material are adhered to the dimensioned strips of flexible material, as indicated in block 40. The one or more additional strips each extend a length beyond the surface of the countertop-receiving structure, with each length representing the desired amount of overhang.

Finally, the strips of flexible material can be cut to from a desired pattern for the integrated template, as indicated in block 50. For example, if a rounded or contoured shape for the countertop is desired, the dimensioned strips may be cut to depict this desired design on the template. Notations as to the desired shape and design of the countertop can also be made by writing on the surface of the strips themselves.

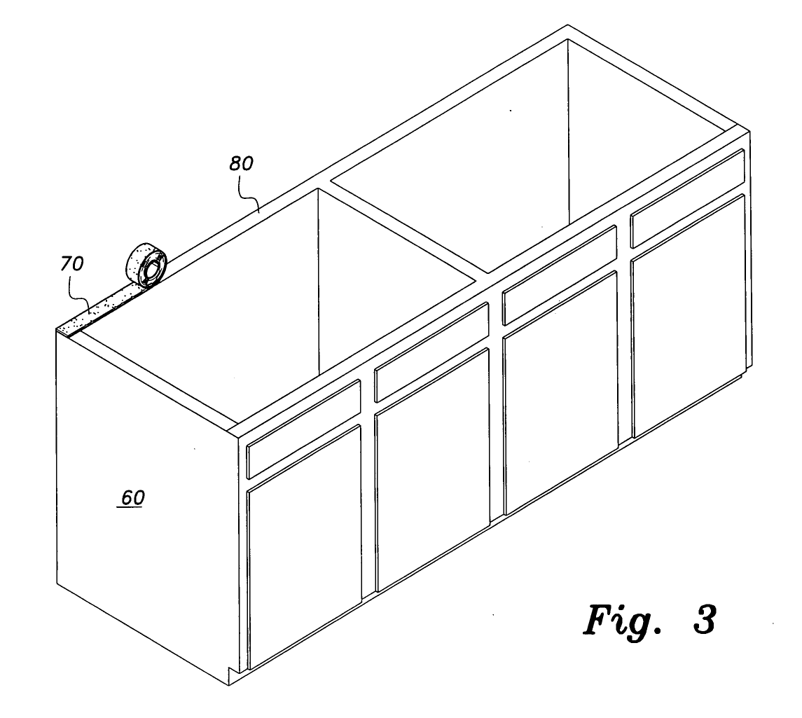

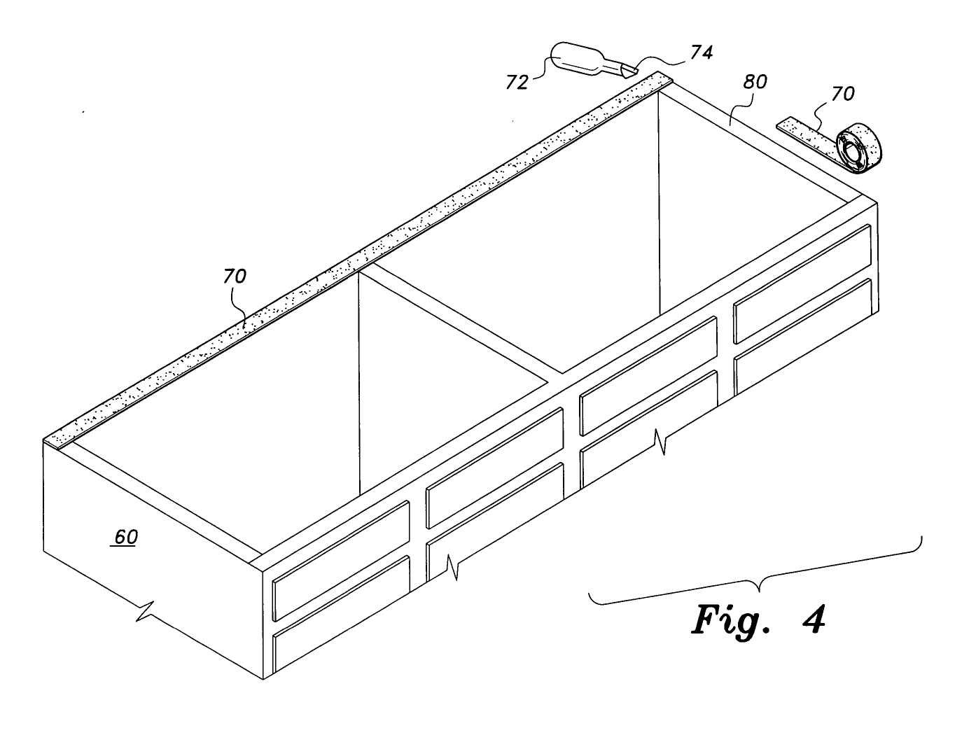

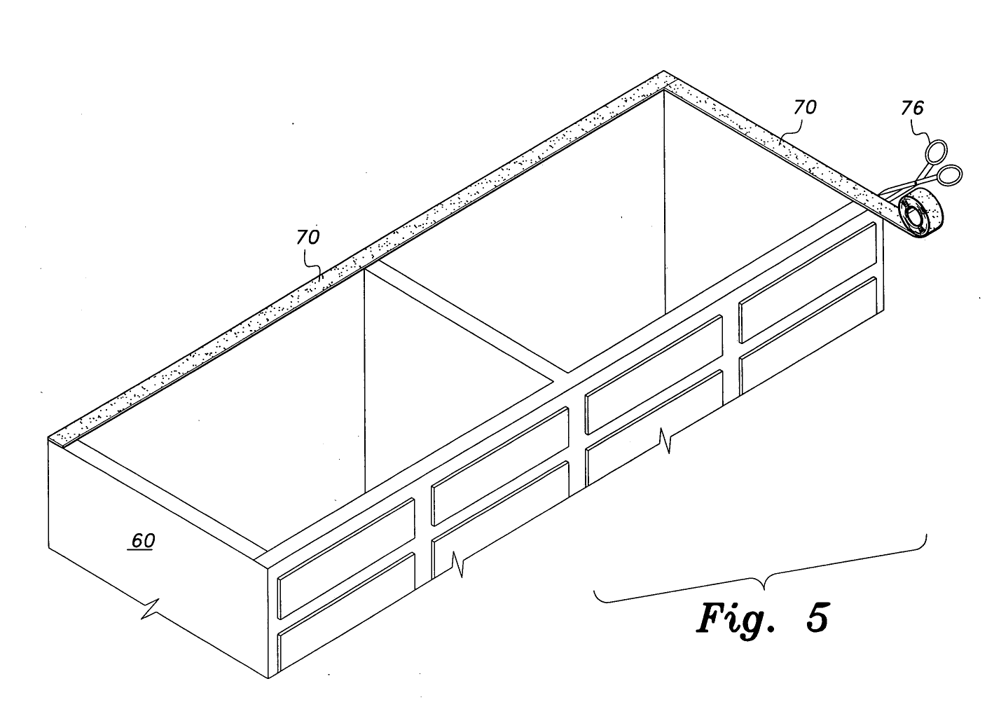

FIGS. 3-5 further illustrate the method for making a template for a countertop, including the items comprising the kit for making a template for a countertop. The countertop-receiving structure, shown as cabinet set 60, is provided with a series of countertop-receiving surfaces 80. Strips of flexible material 70 are provided in roll form and are used to dimension each countertop-receiving surface 80. An adhesive dispenser 72 is used in combination with a funnel 74 to dispense an adhesive at the end of each strip 70 so that the strip may be attached to form a single, integrated template. The funnel 74 is adapted to fit onto the dispensing end of adhesive dispenser 72, thus making it easier to dispense a small amount of adhesive to a desired location on one of the strips of flexible material. A pair of scissors 76 are provided to assist the user in cutting the strips 70 to their correct dimensions and designs.

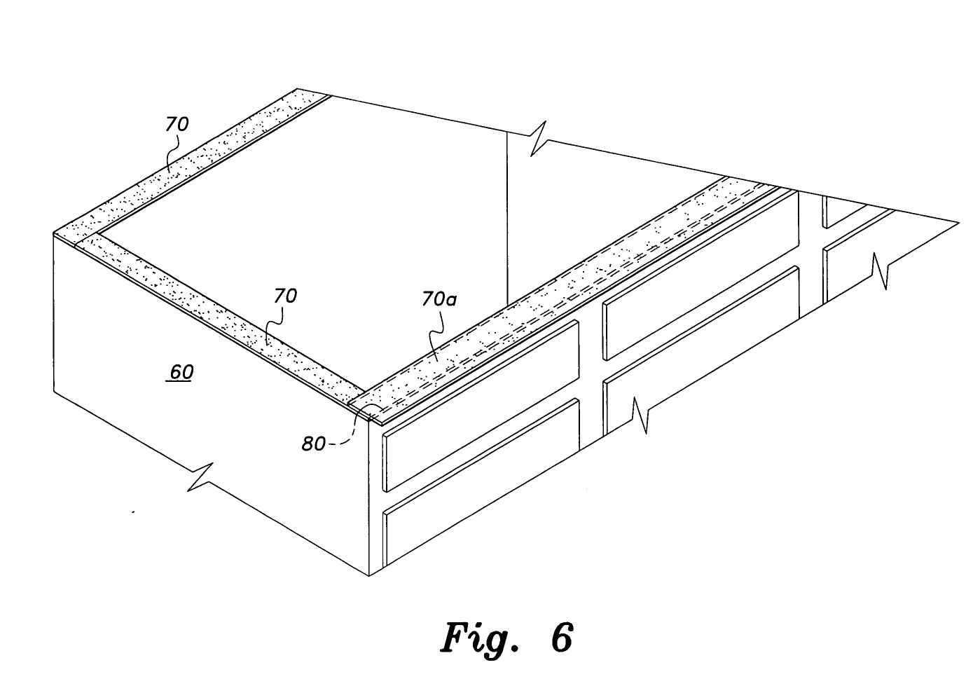

FIG. 6 illustrates the first method of providing for an overhang portion on the countertop template. Strips 70a that are wider than the surface of the countertop-receiving structure 80 they represent can be used, the distance that each strip 70a extends beyond the surface of the countertop-receiving structure 80 representing the desired amount of overhang.

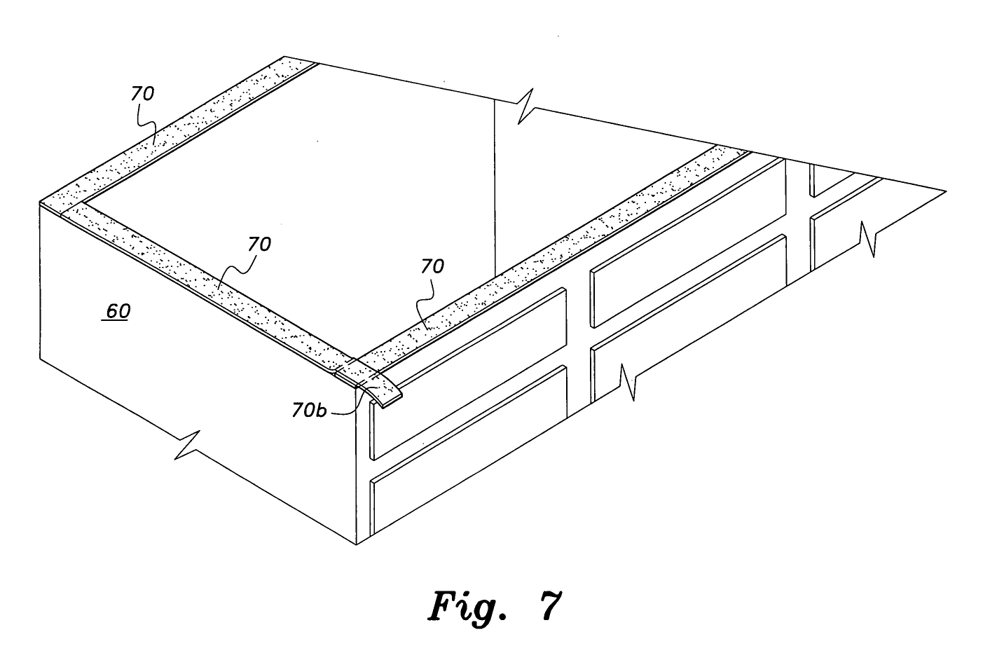

FIG. 7 illustrates an alternate method of providing for an overhang portion on the countertop template. One or more additional strips 70b of flexible material are adhered to the dimensioned strips of flexible material 70. The one or more additional strips 70a each extend a length beyond the surface of the countertop-receiving structure 80, with each length representing the desired amount of overhang.

It is to be understood that the present invention is not limited to the embodiments described above, but encompasses any and all embodiments within the scope of the following claims.

We claim:

1. A method of making a template for a countertop, the template being usable to form a countertop configured for application to an existing countertop-receiving structure, comprising the steps of:
dimensioning the existing countertop-receiving structure with a plurality of strips of a flexible material; and
adhering the dimensioned strips of flexible material to one another to form the integrated template.

2. The method of making a template for a countertop according to claim 1, further including the step of cutting the dimensioned strips of flexible material to a desired pattern, the desired pattern representing the pattern of the countertop.

3. The method of making a template for a countertop according to claim 1, wherein the strips of flexible material have varying widths, the distance that each strip extends beyond the surface of the countertop-receiving structure representing an overhang on the countertop.

4. The method of making a template for a countertop according to claim 1, wherein the strips of flexible material have varying widths, the widths of the strips corresponding to widths of the surfaces of the countertop-receiving structure.

5. The method of making a template for a countertop according to claim 4, further including the step of adhering one or more additional strips of flexible material to the dimensioned strips of flexible material, the one or more additional strips each extending a length beyond the surface of the countertop-receiving structure, each length representing an overhang on the countertop.

6. The method of making a template for a countertop according to claim 1, wherein the flexible material is polyvinyl chloride.

7. The method of making a template for a countertop according to claim 1, wherein the flexible material is polystyrene.

8. The method of making a template for a countertop according to claim 1, wherein the flexible material is Sintra™.

9. The method of making a template for a countertop according to claim 1, wherein the flexible material is Kydex™.

10. A method of making a template for a countertop, the template being usable to form a countertop configured for application to an existing countertop-receiving structure, comprising the steps of:
dimensioning the existing countertop-receiving structure with a plurality of strips of a flexible material, wherein the strips of flexible material have varying widths, the widths of the strips corresponding to widths of the surfaces of the countertop-receiving structure;
adhering the dimensioned strips of flexible material to one another;
adhering one or more additional strips of flexible material to the dimensioned strips of flexible material, the one or more additional strips each extending a length beyond the surface of the countertop-receiving structure, each length representing an overhang on the countertop; and
cutting the dimensioned strips and additional strips of flexible material to form a desired pattern on the integrated template, the desired pattern representing the pattern of the countertop.

11. The method of making a template for a countertop according to claim 10, wherein the flexible material is polyvinyl chloride.

12. The method of making a template for a countertop according to claim 10, wherein the flexible material is polystyrene.

13. The method of making a template for a countertop according to claim 10, wherein the flexible material is Sintra™.

14. The method of making a template for a countertop according to claim 10, wherein the flexible material is Kydex™.

15. A kit for making a template for a countertop, comprising:
one or more rolls of a flexible strip material;
an adhesive;
an adhesive dispenser;
a funnel; and
a pair of scissors.

16. The kit for making a template for a countertop according to claim 15, wherein the funnel is adapted to be attached to the adhesive dispenser.

17. The method of making a template for a countertop according to claim 15, wherein the flexible material is polyvinyl chloride.

18. The method of making a template for a countertop according to claim 15, wherein the flexible material is polystyrene.

19. The method of making a template for a countertop according to claim 15, wherein the flexible material is Sintra™.

20. The method of making a template for a countertop according to claim 15, wherein the flexible material is Kydex™.
